(19) United States
(12) Patent Application Publication
(10) Pub. No.: US 2026/0184160 A1
(43) Pub. Date: Jul. 2, 2026

(54) GAS SUPPLY SYSTEM

(71) Applicant: TOYOTA JIDOSHA KABUSHIKI KAISHA, Toyota-shi (JP)

(72) Inventors: Tetsuya TONOSAKO, Fuji-shi (JP); Naoki TOMI, Kawasaki-shi (JP); Yoshikatsu FUJIMURA, Toyota-shi (JP)

(73) Assignee: TOYOTA JIDOSHA KABUSHIKI KAISHA, Toyota-shi (JP)

(21) Appl. No.: 19/400,279

(22) Filed: Nov. 25, 2025

(30) Foreign Application Priority Data
Dec. 26, 2024 (JP) 2024-229908

(51) Int. Cl. B60K 15/07; B60K 15/01; B60K 15/03

(52) U.S. Cl. CPC B60K 15/07; B60K 15/013; B60K 2015/0319; B60K 2015/03256

(57) ABSTRACT

A gas supply system includes two supports for supporting gas tanks, the supports being movable between a detaching position and a connecting position. A controller of the gas supply system opens a main shut-off valve of a first gas tank while keeping a main shut-off valve of a second gas tank closed, and starts supplying gas. When pressure in the first gas tank reaches a pressure lower-limit value, the controller closes the main shut-off valve of the first gas tank, opens the main shut-off valve of the second gas tank, and moves the first support to the detaching position at which the first gas tank can be detached.

### CROSS-REFERENCE TO RELATED APPLICATION

This application claims priority to Japanese Patent Application No. 2024-229908 filed on December 26, 2024. The disclosure of the above-identified application, including the specification, drawings, and claims, is incorporated by reference herein in its entirety.

### BACKGROUND

### 1. Technical Field

The technology disclosed in the present specification relates to a gas supply system that supplies gas to a gas utilizing device.

### 2. Description of Related Art

Japanese Unexamined Patent Application Publication No. 2024-089965 (JP 2024-089965 A) discloses a gas supply system in which a plurality of gas tanks is connected, and gas is supplied from each of the gas tanks to a gas utilizing device. In this gas supply system, when all of the gas tanks are empty, the gas utilizing device is stopped and the gas tanks are replaced.

### SUMMARY

In the system according to JP 2024-089965 A, supply of gas is interrupted while the gas tanks are being replaced, and accordingly the gas utilizing device has to be shut down. The present specification provides a gas supply system that enables replacement of gas tanks without interrupting gas supply to a gas utilizing device.

The gas supply system disclosed in the present specification includes a first support for supporting a first gas tank, a second support for supporting a second gas tank, a gas supply pipe for introducing gas to a gas utilizing device, first and second actuators, first and second main shut-off valves, and a controller. The first (second) actuator can move the first (second) support between a connecting position in which the first (second) support, to which the first (second) gas tank is attached, is connected to the gas supply pipe, and a detaching position in which the first (second) gas tank can be detached. The first (second) main shut-off valve opens and closes a gas channel between the first (second) gas tank and the gas utilizing device. When the first (second) gas tank is set on the first (second) support, the controller controls the first (second) actuator to move the first (second) support to the connecting position. The controller opens the first main shut-off valve while keeping the second main shut-off valve closed, to supply gas from the first gas tank to the gas utilizing device. When pressure in the first gas tank reaches a pressure lower-limit value, the controller closes the first main shut-off valve, opens the second main shut-off valve, and also moves the first support to the detaching position. Note that "gas tank pressure" refers to the pressure inside the gas tank (i.e., internal pressure of the gas tank).

A user that operates the gas supply system can replace the first gas tank of which the internal pressure has become low. While the user is replacing the first gas tank, the gas utilizing device continues to be supplied with gas from the second gas tank. In the gas supply system according to present specification, gas tanks can be replaced without interrupting gas supply to the gas utilizing device.

Details of the technology disclosed in the present specification and further improvements will be described in the "DETAILED DESCRIPTION OF EMBODIMENTS" below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a gas supply system according to an embodiment;

FIG. 2 is a cross-sectional view of a gas tank and a gas supply pipe (connecting (valve closed) position);

FIG. 3 is a cross-sectional view of the gas tank and the gas supply pipe (connecting (valve open) position);

FIG. 4 is a flowchart of gas tank replacement preparation processing; and

FIG. 5 is a timing chart showing timing for replacing two gas tanks.

### DETAILED DESCRIPTION OF EMBODIMENTS

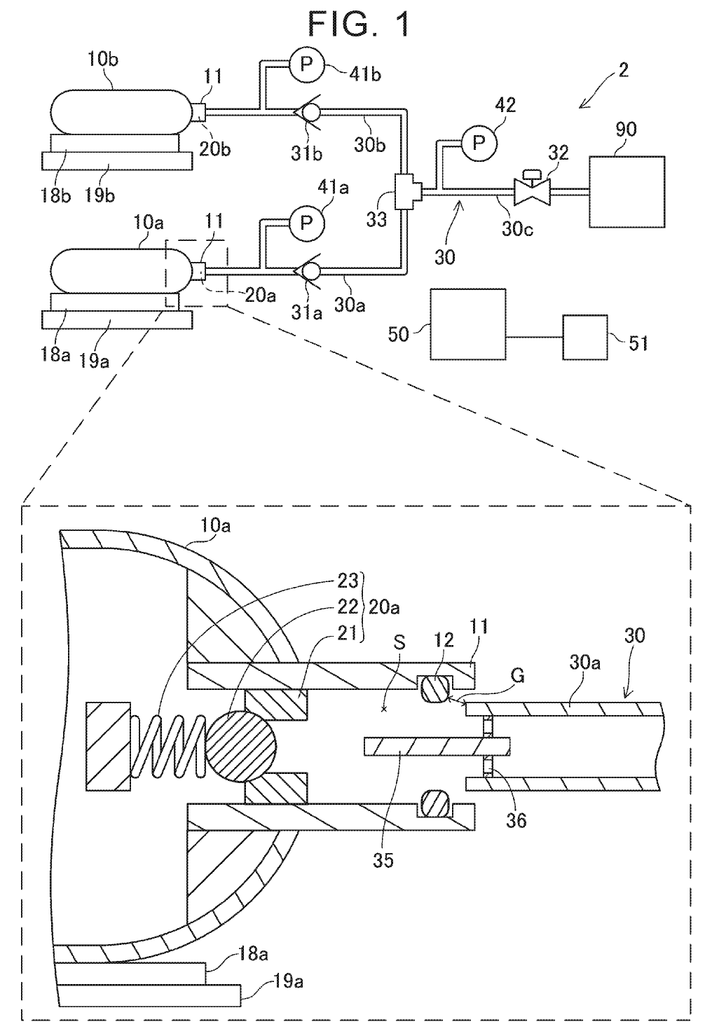

A gas supply system 2 according to an embodiment will be described with reference to the drawings. FIG. 1 is a block diagram of the gas supply system 2. A fuel cell 90 is connected to the gas supply system 2 of the embodiment, and the gas supply system 2 supplies hydrogen gas from a plurality of gas tanks 10a and 10b to the fuel cell 90. The fuel cell 90 is an example of a gas utilizing device to which the gas supply system 2 supplies gas.

The gas supply system 2 includes two gas tanks 10a and 10b, a gas supply pipe 30, supports 18a and 18b, actuators 19a and 19b, pressure sensors 41a, 41b and 42, check valves 31a and 31b, a controller 50, and a display device 51.

The gas tanks 10a and 10b are filled with high-pressure hydrogen gas. The gas tank 10a (10b) is attached to the support 18a (18b). The position of the support 18a (18b) can be changed by the actuator 19a (19b). Movement of the actuator 19a (19b) will be described later. The gas tank 10a (10b) can be detached only when the support 18a (18b) is situated at a specific position (detaching position, which will be described later).

The gas tanks 10a and 10b, and the fuel cell 90, are connected by the gas supply pipe 30. The gas supply pipe 30 is a gas channel that guides the hydrogen gas in the gas tanks 10a and 10b to the fuel cell 90. The gas supply pipe 30 is divided into a first branch pipe 30a and a second branch pipe 30b, and the gas tank 10a is connected to a distal end of the first branch pipe 30a, and the gas tank 10b is connected to a distal end of the second branch pipe 30b. The first branch pipe 30a and the second branch pipe 30b are connected to a common pipe 30c by a three-way joint 33. The fuel cell 90 is connected to one end of the common pipe 30c. The first branch pipe 30a, the second branch pipe 30b, and the common pipe 30c make up the gas supply pipe 30.

The check valve 31a and the pressure sensor 41a are connected to the first branch pipe 30a, and the check valve 31b and the pressure sensor 41b are connected to the second branch pipe 30b. A pressure reducing valve 32 is connected to the common pipe 30c. The pressure reducing valve 32 is disposed downstream of the check valves 31a and 31b. Now, the term "downstream" refers to a side of the gas supply pipe 30 that is closer to the fuel cell 90 (gas utilizing device), and the term "upstream" refers to a side thereof that is closer to the gas tank 10a or 10b.

The pressure reducing valve 32 reduces the pressure of the hydrogen gas supplied from the gas tanks 10a and 10b to a pressure suitable for operation of the fuel cell 90. That is to say, the pressure of the gas suitable for the fuel cell 90 is lower than the pressure of the gas supplied from the gas tanks 10a and 10b. The gas tanks 10a and 10b are initially filled with hydrogen gas to a pressure higher than that suitable for operation of the fuel cell 90.

The check valves 31a and 31b enable gas to pass from upstream to downstream and suppress gas from flowing from downstream to upstream. The check valve 31a (31b) suppresses hydrogen gas from leaking to the outside from downstream of the check valve 31a (31b) when the gas tank 10a (10b) is removed from the gas supply pipe 30. Also, the check valve 31a (31b) suppresses hydrogen gas from leaking to the outside downstream of the check valve 31a (31b) in the event of a gas leak occurring at a connection point between the gas tank 10a (10b) and the gas supply pipe 30.

The pressure sensor 41a (41b) measures the pressure in the gas supply pipe 30 upstream of the check valve 31a (31b). When the gas tank 10a (10b) is connected to the gas supply pipe 30, a measurement value of the pressure sensor 41a (41b) is equal to the pressure of the gas tank 10a (10b). As mentioned above, "pressure of the gas tank 10a (10b)" means the pressure inside the gas tank 10a (10b) (i.e., internal pressure of the gas tank).

The pressure sensor 42 measures the pressure in the gas supply pipe 30 downstream of the check valves 31a and 31b. While gas is being supplied from the gas tank 10a (or gas tank 10b), a measurement value of the pressure sensor 42 is equal to the measurement value of the pressure sensor 41a (or 41b). When the gas tank 10a (10b) is disconnected from the gas supply pipe 30, the pressure in the first branch pipe 30a (second branch pipe 30b) drops to atmospheric pressure, but due to the check valve 31a (31b) being provided, the measurement value of the pressure sensor 42 (i.e., pressure in the common pipe 30c) does not drop.

A main shut-off valve 20a (20b) is incorporated into a neck 11 of the gas tank 10a (10b). The lower part of FIG. 1 illustrates a cross-sectional view of the neck 11 of the gas tank 10a and a distal end of the gas supply pipe 30 (distal end of the first branch pipe 30a). The neck 11 of the gas tank 10a is provided with the main shut-off valve 20a. The main shut-off valve 20a includes a sleeve 21, a valve body 22, and a spring 23. The sleeve 21 is attached on an inner side of the neck 11. The valve body 22 is disposed adjacently to the sleeve 21 within the tank. The spring 23 presses the valve body 22 against an opening of the sleeve 21 (opening that opens into the tank) from inside the tank. An end of the spring 23 on the other side thereof is supported by an inner wall of the tank.

The valve body 22 is in close contact with the opening of the sleeve 21, under force of the spring 23. While the valve body 22 is in close contact with the opening of the sleeve 21, the main shut-off valve 20a is closed. When the valve body 22 is pushed inward from outside of the tank, the main shut-off valve 20a opens. When the load on the valve body 22 is removed, force of the spring 23 causes the valve body 22 to come into close contact with the opening of the sleeve 21 again, and the main shut-off valve 20a closes. This sort of main shut-off valve is sometimes called a "self-closing valve".

A push rod 35 is provided at the distal end of the gas supply pipe 30 (distal end of the first branch pipe 30a). The push rod 35 is fixed to the distal end of the gas supply pipe 30 by a rod support 36. The rod support 36 has a hole that is provided therein, through which gas can flow from the gas tank 10a into the gas supply pipe 30.

When the gas tank 10a is set on the support 18a, the push rod 35 at the distal end of the gas supply pipe 30 faces the neck 11. The actuator 19a moves the first support 18a on which the gas tank 10a is set. The actuator 19a moves the support 18a (i.e., the gas tank 10a) toward or away from the gas supply pipe 30. In other words, the actuator 19a moves the main shut-off valve 20a toward or away from the distal end of the gas supply pipe 30 (i.e., push rod 35). The cross-sectional view of FIG. 1 illustrates a state in which the push rod 35 is away from the main shut-off valve 20a.

The actuator 19a moves the support 18a (gas tank 10a) forward and backward relative to the distal end of the gas supply pipe 30. For the sake of convenience in description, when the support 18a (gas tank 10a) moves closer to the gas supply pipe 30, this is referred to as "moving forward", and when the gas tank 10a moves away from the gas supply pipe 30, this is referred to as "moving backward". The actuator 19a may move the gas supply pipe 30 forward and backward relative to the support 18a (gas tank 10a).

A sealing 12 is disposed inside the neck 11. When the distal end (push rod 35) of the gas supply pipe 30 approaches the main shut-off valve 20a, an outer periphery of the gas supply pipe 30 comes into contact with the sealing 12, thereby sealing off a space that includes the opening of the main shut-off valve 20a (opening that opens to outside of the gas tank 10a) and the distal end of the gas supply pipe 30. The space including the opening of the main shut-off valve 20a and the distal end of the gas supply pipe 30 will be referred to as “connection space S” for the sake of convenience. More precisely, the connection space S refers to space inside the neck 11, including the opening of the main shut-off valve 20a and the distal end of the gas supply pipe 30. In the cross-sectional view of FIG. 1, the push rod 35 is away from the main shut-off valve 20a, and a gap G is maintained between the distal end of the gas supply pipe 30 and the sealing 12. In this state, the connection space S is not sealed off from the external environment.

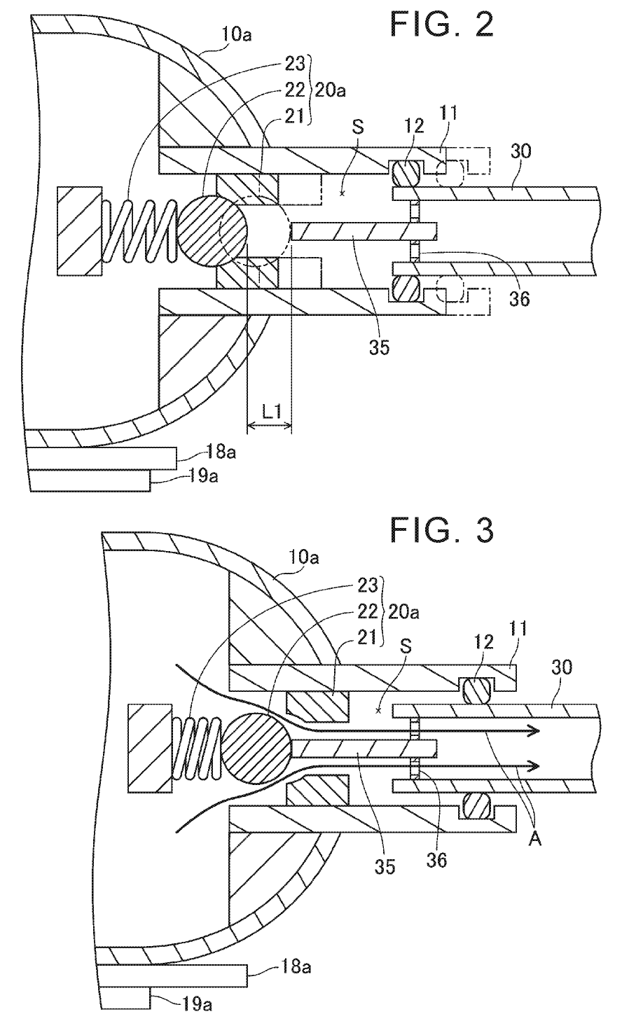

FIG. 2 illustrates a cross section at the time when the distal end of the gas supply pipe 30 is in contact with the sealing 12. When the distance between the push rod 35 and the main shut-off valve 20a reaches L1, the sealing 12 comes into contact with the outer periphery of the gas supply pipe 30, and the connection space S is sealed off. In other words, when the distance between the push rod 35 and the valve body 22 of the main shut-off valve 20a becomes shorter than L1, the connection space S is shut off from the external environment. When the distance between the push rod 35 and the valve body 22 is L1, the main shut-off valve 20a remains closed. The distance L1 may be referred to as a threshold value distance.

The hidden outlines in FIG. 2 indicate a state in which the support 18a (gas tank 10a) has moved forward until the valve body 22 comes into contact with the distal end of the push rod 35. When the gas tank 10a moves further forward than the hidden outlines, the push rod 35 pushes open the main shut-off valve 20a. FIG. 3 is a cross-sectional view at the time when the support 18a (gas tank 10a) has moved forward until the main shut-off valve 20a is opened. Heavy arrows A indicate flow of the gas. While the main shut-off valve 20a is open, the hydrogen gas in the gas tank 10a flows through the connection space S to the gas supply pipe 30. The connection space S is sealed off by the sealing 12, and accordingly the hydrogen gas does not leak to the outside.

The gas in the gas tank 10a passes through the main shut-off valve 20a that is open, passes through the hole in the rod support 36, and flows into the gas supply pipe 30. For the sake of convenience in description, the position of the support 18a (gas tank 10a) when the connection space S is sealed off will be referred to as “connecting position”. FIG. 2 is a diagram illustrating the connecting position when the main shut-off valve 20a is closed. FIG. 3 is a diagram illustrating the connecting position when the main shut-off valve 20a is open. The connecting position when the main shut-off valve 20a is open (the position of the support 18a (gas tank 10a) when the connection space S is sealed and the main shut-off valve 20a is open) is referred to as “connecting (valve open) position” in particular. Conversely, the position of the support 18a (gas tank 10a) when the connection space S is sealed off but the main shut-off valve 20a is closed is referred to as “connecting (valve closed) position”. Also, the position of the support 18a (gas tank 10a) in which the connection space S is unsealed and thus open to the external environment as due to the gas tank 10a moving backward will be referred to as "detaching position" (see FIG. 1).

Although detailed illustration of the mechanism is omitted, when the support 18a to which the gas tank 10a is attached is positioned at the connecting position, the gas tank 10a cannot be removed from the support 18a. Detaching of the gas tank 10a from the support 18a can only be performed when the support 18a is positioned in the detaching position.

FIGS. 2 and 3 illustrate cross sections in the connecting position, and FIG. 3 illustrates a cross section in the connecting (valve open) position. When the support 18a to which the gas tank 10a is attached is positioned in a connecting position (either the connecting (valve closed) position or the connecting (valve open) position), the gas tank 10a is expressed as being connected to the gas supply pipe 30.

When a new gas tank 10a is set on the support 18a, the controller 50 (see FIG. 1) controls the actuator 19a to move the support 18a (gas tank 10a) forward to the connecting (valve open) position. The main shut-off valve 20a opens, and the gas in the gas tank 10a flows through the check valve 31a and the pressure reducing valve 32 to the fuel cell 90. The fuel cell 90 becomes operational. The controller 50 operates the fuel cell 90.

The structure of the gas tank 10b and the distal end of the second branch pipe 30b is the same as the structure of the gas tank 10a and the distal end of the first branch pipe 30a. The gas tank 10b has the main shut-off valve 20b. The structure of the main shut-off valve 20b is the same as the structure of the main shut-off valve 20a. The gas tank 10b is attached to the support 18b. The support 18b (gas tank 10b) is moved between the detaching position and the connecting position by the actuator 19b.

Prior to operating the fuel cell 90, the gas tanks 10a and 10b are set on the supports 18a and 18b, respectively. The gas tanks 10a and 10b set on the supports 18a and 18b are filled with gas to a pressure higher than that suitable for the operation of the fuel cell 90. The controller 50 controls the actuator 19a to move the support 18a (gas tank 10a) from the detaching position to the connecting position (connecting (valve closed) position), and controls the actuator 19b to move the support 18b (gas tank 10b) from the detaching position to the connecting position (connecting (valve closed) position). In the connecting position, the gas tanks 10a and 10b are connected to the gas supply pipe 30.

The controller 50 moves the supports 18a and 18b alternately to the connecting (valve open) position. The controller 50 alternates between using the gas tanks 10a and 10b, enabling one gas tank to be replaced while the other gas tank is supplying gas to the fuel cell 90.

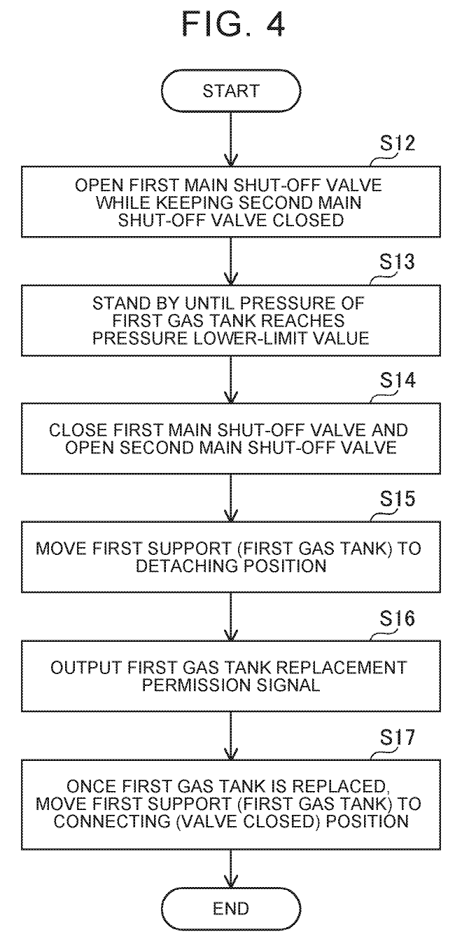

FIG. 4 shows a flowchart of gas tank replacement preparation processing that is executed by the controller 50. Hereinafter, the gas tank 10a will be referred to as “first gas tank 10a”, and the gas tank 10b will be referred to as “second gas tank 10b”. Also, the main shut-off valve 20a will be referred to as “first main shut-off valve 20a”, and the main shut-off valve 20b will be referred to as “second main shut-off valve 20b”. Furthermore, the supports 18a and 18b will be referred to as “first support 18a and second support 18b”, respectively, and the actuators 19a and 19b are referred to as “first actuator 19a and second actuator 19b”, respectively.

The controller 50 controls the actuators 19a and 19b to move the first support 18a to the connecting (valve open) position while keeping the second support 18b in the connecting (valve closed) position. That is to say, the controller 50 opens the first main shut-off valve 20a of the first gas tank 10a while keeping the second main shut-off valve 20b of the second gas tank 10b closed (step S12). Gas is supplied to the fuel cell 90 from the first gas tank 10a. The controller 50 starts operation of the fuel cell 90.

As the fuel cell 90 continues to operate, the pressure in the first gas tank 10a decreases. In other words, the remaining amount of gas in the first gas tank 10a decreases. The controller 50 stands by until the pressure in the first gas tank 10a reaches a pressure lower-limit value (step S13). Note that the pressure lower-limit value is set to a value that is higher than the gas pressure (pressure downstream of the pressure reducing valve 32) that is suitable for operation of the fuel cell 90.

When the pressure in the first gas tank 10a reaches the pressure lower-limit value, the controller 50 controls the first actuator 19a and the second actuator 19b to move the first support 18a, which is positioned in the connecting (valve open) position, to the connecting (valve closed) position, and to move the second support 18b, which is positioned in the connecting (valve closed) position, to the connecting (valve open) position. That is to say, the controller 50 closes the first main shut-off valve 20a and opens the second main shut-off valve 20b (step S14). Gas begins to be supplied to the fuel cell 90 from the second gas tank 10b, which is fully filled with gas. Next, the controller 50 controls the first actuator 19a to move the first support 18a (i.e., the first gas tank 10a) positioned in the connecting (valve closed) position to the detaching position (step S15). The controller 50 outputs a first gas tank replacement permission signal to the display device 51 (step S16). Upon receiving the first gas tank replacement permission signal, the display device 51 displays a message prompting the user to replace the first gas tank 10a (or lights a lamp prompting the user to replace the first gas tank 10a).

As described above, when the first support 18a is positioned in the detaching position, the first gas tank 10a can be removed from the first support 18a. Upon checking the message on the display device 51, the user replaces the first gas tank 10a. Although omitted from illustration, the first support 18a and the second support 18b are provided with attachment/detachment sensors that detect when the gas tanks are removed and when the gas tanks are attached. The controller 50 detects that the first gas tank 10a has been replaced based on a signal from the attachment/detachment sensor.

Upon detecting that the first gas tank 10a has been replaced, the controller 50 controls the first actuator 19a to move the first support 18a (first gas tank 10a) from the detaching position to the connecting (valve closed) position (step S17). That is to say, the controller 50 connects the first gas tank 10a to the gas supply pipe 30 in preparation for replacement of the second gas tank 10b.

The controller 50 stands by until the pressure in the second gas tank 10b reaches the pressure lower-limit value. Thereafter, in the flowchart of FIG. 4, steps S14 to S17 are executed with "first" and "second" interchanged. Thus, the first gas tank 10a and the second gas tank 10b can be alternately replaced without shutting down the fuel cell 90.

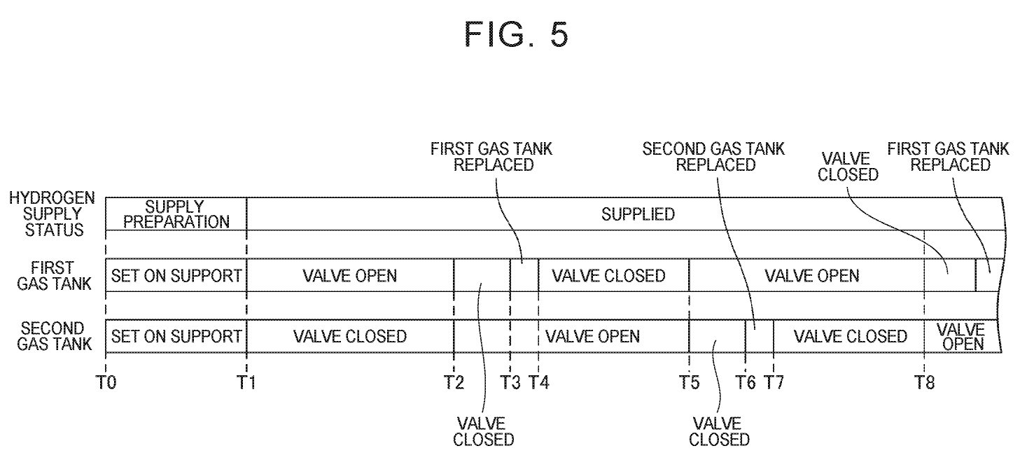

FIG. 5 is a timing chart showing the timing for replacing each of the two gas tanks. The topmost of the three timelines in the timing chart shows the state of supply of hydrogen gas from the gas tanks to the fuel cell 90. Between time T0 and time T1, the user sets the first gas tank 10a on the first support 18a positioned in the detaching position, and sets the second gas tank 10b on the second support 18b positioned in the detaching position. The controller 50 moves the first and second supports 18a and 18b to the connecting (valve closed) position, and connects the first and second gas tanks 10a and 10b set on the first and second supports 18a and 18b to the gas supply pipe 30. At time T1, the controller 50 opens the first main shut-off valve 20a while keeping the second main shut-off valve 20b closed. The controller 50 starts operation of the fuel cell 90. As the fuel cell 90 operates, the pressure in the first gas tank 10a decreases.

At time T2, the pressure in the first gas tank 10a reaches the pressure lower-limit value. At time T2, the controller 50 closes the first main shut-off valve 20a and also opens the second main shut-off valve 20b. Gas begins to be supplied from the second gas tank 10b to the fuel cell 90. The controller 50 moves the first support 18a (first gas tank 10a) to the detaching position. The first gas tank 10a of the first support 18a that has been moved to the detaching position is now in a state in which it can be detached. Note that the first branch pipe 30a to which the first gas tank 10a was connected is equipped with the check valve 31a, and accordingly even when the first support 18a (first gas tank 10a) is moved from the connecting (valve closed) position to the detaching position, the gas in the second gas tank 10b will not leak to the outside through the first branch pipe 30a.

While gas is being supplied from the second gas tank 10b to the fuel cell 90, between time T3 and time T4, the user replaces the old first gas tank 10a with a new first gas tank 10a that is fully filled with gas. The controller 50 moves the first support 18a (first gas tank 10a) to the connecting (valve closed) position. That is to say, the controller 50 connects the first gas tank 10a to the gas supply pipe 30.

At time T5, the pressure in the second gas tank 10b drops to the pressure lower-limit value. At time T5, the controller 50 closes the second main shut-off valve 20b and also opens the first main shut-off valve 20a. Gas begins to be supplied from the first gas tank 10a to the fuel cell 90. The controller 50 moves the second support 18b (second gas tank 10b) from the connecting (valve closed) position to the detaching position. The second gas tank 10b that has been moved to the detaching position is now in a state in which it can be detached. As in the previous case, the second branch pipe 30b is provided with the check valve 31b, and accordingly the gas in the second gas tank 10b will not leak to the outside through the second branch pipe 30b.

While gas is being supplied from the first gas tank 10a to the fuel cell 90, between time T6 and time T7, the user replaces the old second gas tank 10b with a new second gas tank 10b that is fully filled with gas. The controller 50 moves the second support 18b (second gas tank 10b) to the connecting (valve closed) position. That is to say, the controller 50 connects the second gas tank 10b to the gas supply pipe 30.

The above processing is repeated as long as the fuel cell 90 is in operation. The gas supply system 2 enables the gas tanks to be replaced without interrupting the gas supply to the fuel cell 90.

Points to be noted regarding the technology described in the embodiment will be described. The gas supply system 2 of the embodiment includes two gas tanks (first gas tank 10a and second gas tank 10b), and the two gas tanks are alternately moved to replaceable positions (detaching positions). While one gas tank is positioned at the detaching position, the other gas tank is connected to the gas supply pipe 30, the main shut-off valve is opened, and gas is supplied to the fuel cell 90. The gas tank replacement preparation processing executed by the controller 50 is as follows.

(1) When the first gas tank 10a is set on the first support 18a, the controller 50 controls the first actuator 19a to move the first support 18a to the connecting (valve closed) position. When the second gas tank 10b is set on the second support 18b, the controller 50 controls the second actuator 19b to move the second support 18b to the connecting (valve closed) position.

(2) The controller 50 moves the first support 18a to the connecting (valve open) position while keeping the second support 18b in the connecting (valve closed) position. That is to say, the controller 50 opens the first main shut-off valve 20a while keeping the second main shut-off valve 20b closed, and starts supplying gas from the first gas tank 10a to the fuel cell 90.

(3) When the pressure in the first gas tank 10a drops to the pressure lower-limit value, the controller 50 moves the first support 18a to the detaching position and also moves the second support 18b to the connecting (valve open) position. That is to say, when the pressure in the first gas tank 10a drops to the pressure lower-limit value, the controller 50 closes the first main shut-off valve 20a, opens the second main shut-off valve 20b, and moves the first support 18a to the detaching position. When the first support 18a moves to the detaching position, the first gas tank 10a becomes replaceable.

The gas supply system may include three or more gas tanks. The fuel cell 90 according to the embodiment is an example of the gas utilizing device. The gas utilizing device may be a device other than the fuel cell 90.

Although specific examples of the present disclosure have been described in detail above, the examples are merely exemplary and do not limit the scope of claims. The technology described in the claims includes various modifications and variations of the specific example exemplified above. The technical elements described in the present specification or in the drawings exhibit technical usefulness alone or in various combinations, and are not limited to the combinations described in the claims at the time of filing the application. Also, the technology exemplified in the present specification or in the drawings can achieve a plurality of purposes at the same time, and achieving one of the purposes itself has technical usefulness.

What is claimed is:

1. A gas supply system comprising:
a first support that supports a first gas tank;
a second support that supports a second gas tank;
a gas supply pipe for introducing gas to a gas utilizing device;
a first actuator that moves the first support between a connecting position at which the first gas tank is to be connected to the gas supply pipe, and a detaching position at which the first gas tank is detachable;
a second actuator that moves the second support between a connecting position at which the second gas tank is to be connected to the gas supply pipe, and a detaching position at which the second gas tank is detachable;
a first main shut-off valve that opens and closes a gas channel between the first gas tank and the gas utilizing device;
a second main shut-off valve that opens and closes a gas channel between the second gas tank and the gas utilizing device; and
a controller, wherein
the controller, upon the first gas tank being set on the first support,
controls the first actuator to move the first support to the connecting position, and upon the second gas tank being set on the second support, controls the second actuator to move the second support to the connecting position,
opens the first main shut-off valve while keeping the second main shut-off valve closed, to supply gas from the first gas tank to the gas utilizing device, and
when pressure in the first gas tank reaches a pressure lower-limit value, closes the first main shut-off valve,
opens the second main shut-off valve, and moves the first support to the detaching position.
